(19) United States
(12) Patent Application Publication
(10) Pub. No.: US 2013/0132119 A1
(43) Pub. Date: May 23, 2013

(54) REPORT GENERATOR FOR A MEDICAL IMAGE READING SYSTEM

(71) Applicant: Advanced Medical Imaging and Teleradiology, LLC, Jericho, NY (US)

(72) Inventors: Naiyer Imam, Roanoke, VA (US); Ron Mark, Jericho, NY (US)

(73) Assignee: ADVANCED MEDICAL IMAGING AND TELERADIOLOGY, LLC, Jericho, NY (US)

(21) Appl. No.: 13/683,554

(22) Filed: Nov. 21, 2012

Related U.S. Application Data
(60) Provisional application No. 61/563,300, filed on Nov. 23, 2011.

(51) Int. Cl. G06F 19/00

(52) U.S. Cl. CPC G06F 19/321
USPC 705/3

(57) ABSTRACT

A teleradiology processing system comprises a central reading station having a plurality of computer work areas, a plurality of transcriptionist stations each having a transcriptionist computer, a shared audio communication channel that facilitates audio communication between the centralized teleradiology location and each of the transcriptionist stations and a database that stores a plurality of medical case files, where the database is accessible by each of the plurality of transcriptionist computers. In operation, each transcriptionist computer takes control of a uniquely assigned one of the plurality of computer work areas to provide information from a pre-fetched medical case. Moreover, each transcriptionist computer prepares a report based upon the medical case file and a tech sheet containing a measurement of at least one feature of a medical image. Each report, once approved by the specialist at the centralized teleradiology location, is written to the database.

### CROSS-REFERENCE TO RELATED APPLICATIONS

This application claims the benefit of U.S. Provisional Patent Application Ser. No. 61/563,300, filed Nov. 23, 2011, the disclosure of which is hereby incorporated by reference in its entirety.

### BACKGROUND

The present disclosure relates to teleradiology systems and in particular, to systems that improve teleradiology throughput of medical image analysis and report generation.

Teleradiology comprises the transmission of radiological patient images and related information from one location to another for purposes of evaluation (e.g., interpretation or consultation). For instance, a hospital can capture medical images such as X-rays, Magnetic Resonance Imaging (MRI) scans, computerized axial tomography (CAT) scans, etc. as digital medical image files. The hospital can then upload the captured medical image files to a remote image server. A corresponding domain expert, e.g., an MRI Radiologist, Neuroradiologist, etc., can then retrieve the necessary medical image files from the remote image server for evaluation. Upon completing the evaluation, the domain expert submits a report back to the hospital. As such, the specialist and hospital do not need to be co-located.

### BRIEF SUMMARY

According to aspects of the present disclosure, a method of preparing and processing medical reports is disclosed. The method comprises preparing a first medical case for evaluation by a first transcriptionist computer. The preparation is performed by pre-fetching a first medical case file having at least one medical image from a database, selecting a modality of the at least one medical image (e.g., magnetic resonance imaging (MRI), computerized tomography (CT), positron emission tomography (PET-CT), ultrasound, plain film X-ray, etc.), selecting a body area associated with the selected modality and automatically selecting a report type based upon the selected modality and selected body area. The preparation is further performed by applying one or more rules to determine whether at least an aspect of the medical image is normal or abnormal. The preparation is still further performed by utilizing information from the results of the applied rules and the selected report type to automatically generate a preliminary report having a preliminary finding.

The method further comprises transferring the medical image of the first medical case file and the preliminary report to a first specialist computer work area of a central reading station. The first computer work area is remote from the first transcriptionist computer. The method still further comprises receiving a response from the central reading station and sending a final version of the report associated with the first medical case file to the database for storage after receiving approval from the first computer work area.

According to further aspects of the present disclosure, another method of preparing and processing medical reports is disclosed. The method comprises connecting to a database that stores a plurality of medical case files. The database is accessible by a transcriptionist station having a transcriptionist computer. The method further comprises providing information from a medical case file to a central reading station. The medical case file has at least one medical image for analysis and a tech sheet that stores at least one measurement of a feature in the corresponding medical image.

The medical case file is provided to the central reading station by obtaining the medical case file from the database, parsing the tech sheet associated with the obtained medical case file and identifying at least one measurement in the tech sheet. The medical case file is further provided to the central reading station by automatically applying at least one rule to determine whether at least one measurement is normal or abnormal, and automatically generating a report by the transcriptionist computer. The medical case file is further provided by providing information from the obtained medical case file, including at least one medical image and the report, to the central reading station. The method still further comprises storing the report in the database once approved by the specialist at the centralized reading station.

### BRIEF DESCRIPTION OF THE SEVERAL VIEWS OF THE DRAWINGS

FIG. 1 is an overall system diagram of a teleradiology system according to aspects of the present disclosure;

FIG. 2 is a block diagram illustrating the relationship between a central reading station and a plurality of transcriptionists stations, according to aspects of the present disclosure;

FIG. 3 is a flow chart illustrating an exemplary flow of medical image reading using the system of FIGS. 1 and 2, according to aspects of the present disclosure;

FIG. 4 is a flow chart illustrating an exemplary flow for a report generator for an ultrasound;

FIG. 5 is a block diagram of a system for generating reports based upon an ultrasound evaluation; and

FIG. 6 is a block diagram of a computer having computer readable program code for carrying out aspects of the present disclosure described more fully herein.

### DETAILED DESCRIPTION

According to various aspects of the present disclosure, systems, methods, and computer program products are provided that facilitate expeditious teleradiology image processing and report generation.

In certain illustrative aspects of the present disclosure, a teleradiology system for processing medical images includes a centralized teleradiology location, a plurality of transcriptionist stations and a shared audio communication channel that facilitates audio communication between the centralized teleradiology location and each transcriptionist station. The teleradiology system also includes access to a database, e.g., accessed through a picture archiving and communication system (PACS) server. The database stores a plurality of medical case files, each medical case file having at least one medical image for analysis.

The centralized teleradiology location includes at least one central reading station. Each central reading station is associated with a single specialist (e.g., a domain expert at interpreting MRI, CT, PET/CT, ultrasound, plain film, etc.) and includes a plurality of computer work areas.

Further, each transcriptionist station has a transcriptionist computer associated with a transcriptionist. Each transcriptionist computer is communicably coupled to the database to obtain a medical case file from the database. Basically, the transcriptionist computer pre-fetches a medical case file (including a medical image and optionally, a tech sheet that includes at least one measurement of a feature in the corresponding medical image if available) from the database. The transcriptionist computer parses the information in the medical file to generate a preliminary report. For instance, the transcriptionist can parse the tech sheet and identify a measurement in the tech sheet. Any identified measurements are automatically entered into the report. Based upon the measurement or other information, the transcriptionist can generate a preliminary finding that is included in the preliminary report.

Each transcriptionist computer is also communicably coupled to a uniquely assigned work area of an associated central reading station. The transcriptionist computer takes control of the uniquely assigned computer work area to provide initial information from the obtained medical case file to a display of the assigned computer work area. This initial information may include the preliminary report, which can include preliminary findings as will be described in greater detail herein.

In this manner, the specialist working at the central reading station has a plurality of computer work areas, each work area uniquely associated with a corresponding transcriptionist computer and correspondingly, a different medical case file that is pre-loaded with information necessary to make a medical diagnosis. The specialist can review each medical case file in-turn and dictate any necessary medical findings back to the transcriptionist stations.

More particularly, each transcriptionist computer is operatively configured to prepare a report or modify a preliminary report (where provided) based upon a code transmitted from the central reading station to the corresponding transcriptionist station (e.g., over the shared audio communication channel). The code encapsulates the medical diagnosis as specified by the specialist working at the central reading station. The transcriptionist computer extracts all of the necessary details from the code to generate a complete/finalized report diagnosing the medical issue associated with the medical case file displayed in the associated work area. For instance, the transcriptionist computer converts the codes into descriptions that are entered into or otherwise become, a report (e.g., a report of medical findings based upon an interpretation by the specialist). Moreover, an optional random generator can convert certain words or phrases of the descriptions into similar words (i.e., synonyms) or phrases to generate reports such that all of the reports generated are not identical.

Each transcriptionist computer is also operatively configured to provide the final report back to the assigned computer work area. Typically, the final report is presented along with the medical image to provide a “second look”: to the specialist. Once the final report is approved by the specialist at the centralized teleradiology location that report is written to the database.

Accordingly, the transcriptionist computers work as a team to queue medical image and other patient information, process the analysis from a specialist, and prepare and deliver reports to the corresponding work area of the central reading station, thus enhancing the workflow and efficiency of a teleradiology specialist. The transcriptionists are not required to be co-located with the specialist. In other words, the transcriptionists can be in a separate location from the specialist. As such, the specialist communicates with the transcriptionists (and transcriptionist computers) through the system of communication distributed between the central reading station operated by the specialist and the corresponding team of transcriptionist computers, each operated by a corresponding transcriptionist.

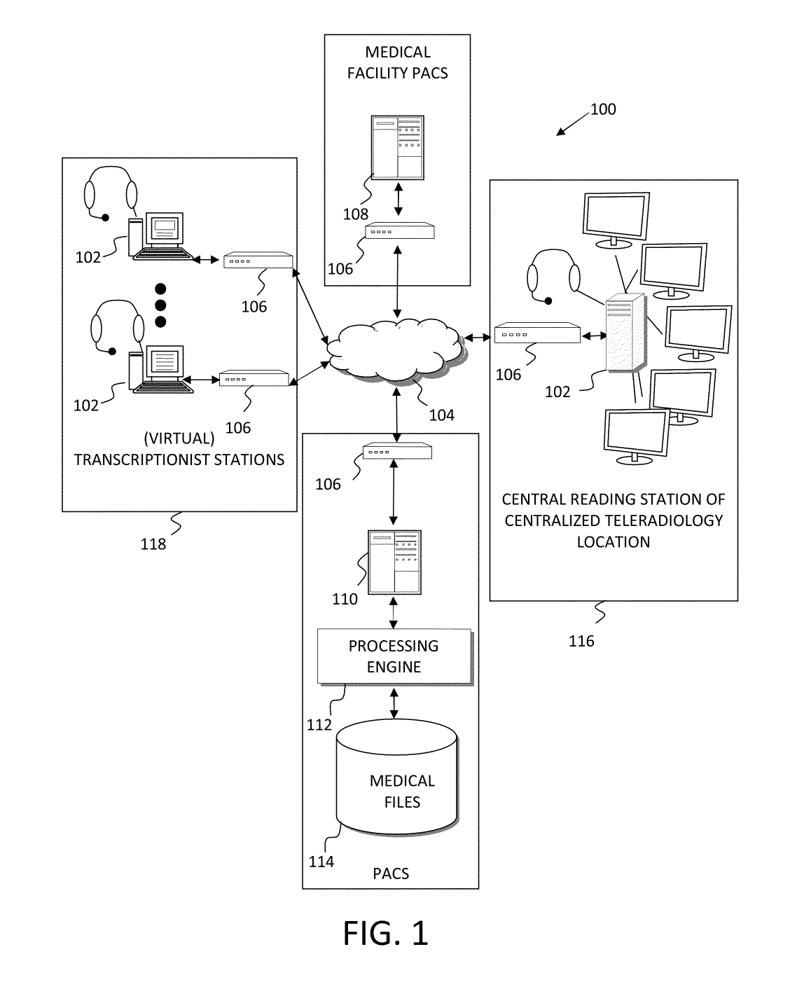

Referring now to the drawings and particularly to FIG. 1, a general diagram of a computer system 100 is illustrated according to various aspects of the present disclosure. The computer system 100 can be utilized to support a teleradiology system as described in greater detail herein. The computer system 100 comprises a plurality of hardware and/or software processing devices, designated generally by the reference 102 that are linked together by a network 104. Typical processing devices 102 include for example, personal computers, servers, notebook computers, transactional systems, purpose-driven appliances, and other devices capable of communicating over the network 104.

The network 104 provides communications links between the various processing devices 102, and may be supported by networking components 106 that interconnect the processing devices 102, including for example, routers, hubs, firewalls, network interfaces, wired or wireless communications links and corresponding interconnections, cellular and other telephone links, network switches, and/or other arrangements for enabling communication between the processing devices 102.

The illustrative system 100 includes a server 108 at a medical facility (e.g., a web server, file server or other processing device). The server 108 provides storage of, and access to, images from multiple modalities, i.e., images from various medical imaging technologies, such as magnetic resonance imaging (MRI), computerized tomography (CT), positron emission tomography (PET-CT), ultrasound, plain film X-ray, etc. In this regard, the server 108 may comprise, for instance, a PACS server.

The illustrative system 100 also includes a server 110 (e.g., a web server, file server, PACS server, other processing device (or combinations thereof)) that supports a processing engine 112 and a corresponding database 114. The processing engine 112 and database 114 provide a centralized processing system that facilitates teleradiology image processing systems as described more fully herein.

In general, sources such as medical facilities require an expert to evaluate (e.g., interpret, diagnose, consult on, or otherwise review) medical image data. As such, the medical facility transfers a medical case file including at least one medical image from their PACS server (e.g., server 108) to the server 110 (e.g., the PACS server of the teleradiology system). The specialists working for the teleradiology system review the medical case files sent to the PACS 110 and generate a report of the medical findings, which is communicated back to the requestor (e.g., the medical facilities associated with the PACS server 108).

According to various aspects of the present disclosure, a teleradiology system includes at least one centralized teleradiology location 116. The centralized teleradiology location 116 includes one or more specialist computer workstations, each specialist computer workstation referred to herein as a central reading station. Each central reading station is operated by a specialist (or a sub-specialist) at reading medical images and includes a plurality of computer work areas. Each computer work area may comprise a separate processing device 102, e.g., a separate computer and corresponding separate display. Alternatively, a single processing device 102 may implement one or more computer work areas. In this regard, the processing device 102 may be coupled to a display per computer work area, or the processing device 102 may be coupled to a single display such that each computer work area is displayed in a corresponding display area within a relatively larger display. Regardless, each computer work area is uniquely allocated to processing a different medical case file. Thus, a single computer may run multiple instances of software, each software instance associated with a computer work area; a single computer may run multiple threads, each thread associated with a computer work area; a virtual machine operating on one or more physical machines may be uniquely allocated to each computer work area, multiple physical machines may be used such that there is a separate physical machine per computer work area, combinations thereof, etc.

For example, as illustrated, the processing device 102 of the teleradiology location 116 includes five displays (corresponding to at least five computer work areas) to illustrate the ability for a single specialist to process multiple medical case files at a time. However, in practice, any number of computer work areas may be implemented, depending upon the resources available to the specialist. In certain illustrative implementations, there are at least two computer work areas. Because a single specialist operates all of the computer work areas within a single central reading station, all computer work areas of that central reading station are co-located.

Further, as noted above, multiple computer work areas may be displayed on one display or display device. Keeping with the above example, the five computer work areas may be displayed on less than five displays. Thus, all five computer work areas can be displayed on one display. This allows the use of a single computer and display (e.g., a laptop computer), to run multiple computer work areas. In this implementation, navigation software is provided (e.g., via tab, index or otherwise) to allow the specialist to navigate from computer work area to computer work area. Still further, one display can include two or more computer work areas at the same time (e.g., by splitting the display screen, etc.).

As an example, a physical computer implementing the central reading station can run multiple virtual machines, where each virtual machine is associated with a corresponding computer work area. In such implementations, there will be one virtual machine for each work area. However, the virtual machines, and hence the computer work areas will share the number of available displays. Still further, any number of virtual machines can be executed, where each virtual machine runs one or more computer work areas. Thus, the computer work areas may be implemented by software executed by virtual machines such that the number of computer work areas is larger than the number of displays at the central reading station. In other implementations, any combination of physical displays and virtual machines may be utilized to implement the desired number of computer work areas. Still further, the virtual machines can be split across one or more physical computer devices.

The system 100 also includes at least one transcriptionist station 118. In operation, a transcriptionist station 118 is uniquely associated with a computer work area of the central reading station. In illustrative implementations, there is a unique transcriptionist station 118 for each computer work area. As an example, assume that there are five computer work areas corresponding to the five illustrated displays within the central reading station at the centralized teleradiology location 116. Thus, there are five transcriptionist stations 118 associated with the central reading station, each associated with a unique computer work area.

Each transcriptionist station includes a processing device 102, (e.g., a transcriptionist computer). In illustrative implementations, the transcriptionist computers are not co-located with the central reading station (i.e., the transcriptionist computers are separate from the central reading station). This allows transcriptionists to be distributed, even in completely different geographic locations, and still interact over the network 104 (e.g., the Internet), with the central reading station. Moreover, the various transcriptionist stations 118 do not need to be co-located with each other. Rather, the transcriptionist stations 118 can be distributed so long as the transcriptionist station 118 can access medical case files via the processing engine 112 and the database 114 of the server computer 110, and the transcriptionist station 118 can access the associated specialist computer work area, as will be described in greater detail herein.

As such, the server 110, processing engine 112 and medical files stored in the database 114 can be co-located with the centralized teleradiology location 116 or with one or more of the transcriptionist stations 118. Alternatively, the server 110, processing engine 112 and medical files stored in the database 114 can be remotely located from both the centralized teleradiology location 116 and the transcriptionist stations 116. Moreover, the server 110 can execute the virtual machines of the central reading station, or the virtual machines of the central reading station can be executed by other physical hardware, e.g. (a desktop or laptop computer (or computers)). Likewise, the server 110 can execute the transcriptionist computers (e.g., as virtual machines) or the transcriptionist computers can be executed by separate hardware (e.g., a desktop or laptop computer (or computers)) at a remote location.

A transcriptionist operates a corresponding transcriptionist computer 102. In this regard, the “transcriptionist” can be a human operator, implemented as transcriptionist software, or both. In an illustrative implementation, the transcriptionist software includes voice recognition software capable of converting specialist instructions into a medical report.

Where the “transcriptionist” is a process (e.g., one or more applications executed in software, hardware, or combinations thereof) the process may be implemented in any practical manner. For instance, the transcriptionists can be implemented on a virtual machine on a server that is located at the centralized teleradiology location 116 or some other location. In this regard, the transcriptionist computer can be a stand-alone computer, a virtual machine, etc.

The transcriptionist software includes a “workflow manager” component that automates work flows. In an illustrative implementation, the workflow manager obtains a medical file from the database 114, takes remote computer control or shared computer control of the associated computer work area of a centralized reading station, and configures the display area associated with the specialist work area to output medical information related to the obtained medical file. The workflow manager also facilitates pre-fetching information from a medical case file, such as a tech sheet, processing the tech sheet included in the medical case file to extract measurement and other data, etc., to prepare an initial draft of a report. When the specialist dictates or otherwise conveys the necessary codes, the workflow manager converts (transforms) the code into a written explanation of the medical diagnosis, which is inserted into the report. Also, the workflow manager finalizes the report once approved by the specialist and sends the finalized report back to the necessary source. Actions of the workflow manager and the transcriptionist computer are discussed in greater detail herein.

In general, the transcriptionist stations 118 cooperate with the specialist operating the central reading station to extract medical case files from the database 114, to generate medical reports and to store the medical reports back out to the database 114 and/or submit the medical reports to the requesting source (e.g., the medical facility associated with server computer 108). As such, at times, the transcriptionist stations 118 are controlling, loading, configuring, or otherwise manipulating the computer work areas of the central reading station.

Accordingly, the teleradiology system, according to an illustrative implementation, can incorporate the server computer 110, the teleradiology location 116, transcriptionist stations 118, or combinations thereon, even though such features can be distributed across one or more networks, co-located, not co-located (remotely located), etc.

The system 100 also includes a shared audio communication channel (illustrated by the headsets), which provides an audio communication channel between the specialist working at a central reading station, and each of the transcriptionists operating a corresponding transcriptionist station. The shared audio communication channel provides a second connection between each central reading station and each transcriptionist station 118, as will be described in greater detail herein.

The simplified illustration of FIG. 1 is provided for purposes of clarity of illustration and not limitation. For instance, although only one medical facility server 108 is illustrated, in practice, numerous medical facilities can send medical case files containing medical images to the server 110 of the teleradiology system for analysis. Moreover, although described using a PACS for convenience and clarity, the various aspects of the present disclosure are not limited to a PACS. Rather, any system can be utilized so long as the teleradiology specialist can view and analyze medical images. Further, in practice, one or more central reading stations can be utilized. In this regard, the central reading stations do not need to be co-located together. Still further, each central reading station can utilize multiple computer work areas. However, each central reading station can utilize a different number of computer work areas (e.g., some specialists may be comfortable working with five work areas, while others may be comfortable working with more or less than five work areas).

FIG. 1 is presented in schematic form. Thus, the server computers 108 and 110 may schematically represent one or more servers, each server performing a different function. For instance, the server computer 110 may comprise any combination of web servers, file servers, back-end processing servers, etc., as is necessary to support the functionality of the processing engine 112 and database 114.

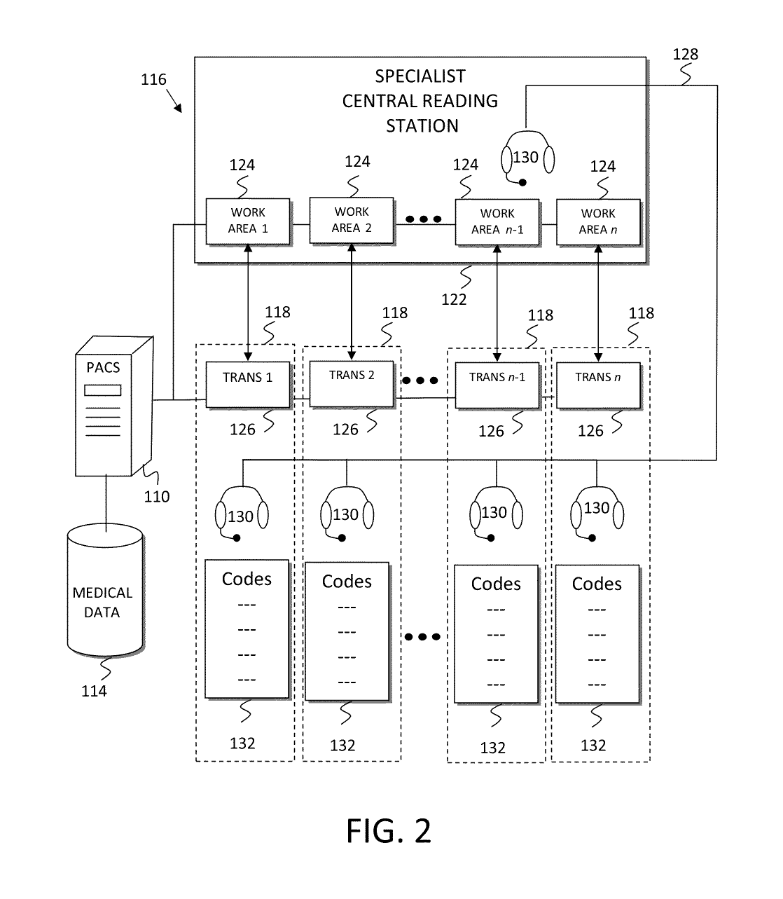

Referring to FIG. 2, an exemplary illustration is provided to demonstrate a simplified teleradiology system according to aspects of the present disclosure. The illustrated central teleradiology location 116 includes a single central reading station 122 (for clarity of discussion only), which is implemented as a specialist computer workstation. The central reading station 122 includes a plurality of computer work areas 124. For instance, there are n computer work areas illustrated where n>1 in this illustrative implementation. Each computer work area 124 independently executes the necessary software for processing a medical case file including the display and optional manipulation of image data associated with that case file. For instance, each computer work area 124 may be capable of executing word processing software, spreadsheet software, image processing software, report generating software, etc., necessary to complete a diagnosis and generate a report for a medical case file. Accordingly, the central reading station 122 is capable of displaying n separate medical case files at the same time. A single specialist operates the central reading station 122 as will be described in greater detail herein.

A plurality of transcriptionist stations 118 is also provided. For purposes of illustration, each transcriptionist station 118 includes a transcriptionist computer 126 that is not co-located with the central reading station 122 to illustrate the flexibility of the present disclosure. As noted herein, the transcriptionist stations 118 do not need to be co-located. In the illustrative implementation, the central reading station 122 and each of the transcriptionist computers 126 can access the server computer 110 and corresponding database 114 to access stored medical case files.

The system also includes a shared audio communication channel 128 that facilitates audio communication between the specialist at the central reading station 122 and each of the transcriptionist stations 118. For instance, an audio interface 130 such as a headset, separate microphone and speaker, telephone, conference call phone, speakerphone, etc., is provided for the specialist and at each transcriptionist station (e.g., for each transcriptionist). The audio interface 130 may alternatively be wired to the transcriptionist computer 126 where the transcriptionist is a virtual transcriptionist. The shared audio communication channel 128 may comprise a telephone connection, cellular, a voice over Internet protocol (VOIP) or other form of communication that allows audio communication between the specialist at the central reading station 122 and each transcriptionist station 118. In this regard, in certain implementations, the shared audio communication channel 128 is open so that all parties can communicate and listen to communications. The specialist at the central reading station 122 may also be able to control the shared audio communication channel 128 (e.g., to solo out one or more transcriptionists for communication while muting out other transcriptionists, so that only select transcriptionists are able to access the limited communication).

As will be described in greater detail herein, each transcriptionist computer 126 obtains a next medical case file from the database 114. Each transcriptionist computer 126 takes control of a uniquely assigned one of the plurality of computer work areas 124 of the central reading station 122 to provide information from the obtained medical case file, including at least one medical image, to a display or display area of the central reading station 122 that is associated with the corresponding computer work area 124. Each transcriptionist computer 126 prepares a report based upon a received code transmitted to the corresponding transcriptionist station 118 over the shared audio communication channel 128. For instance, the transcriptionist can be a person that receives the code by hearing the code announced by the specialist over the shared audio communication channel. The transcriptionist hearing the code generates the necessary report. Alternatively, the transcriptionist may comprise a virtual transcriptionist implemented by a computer operatively configured to automatically prepare the report based upon the received code transmitted from the central reading station. Here, the virtual transcriptionist can use computer code such as voice recognition code to translate the dictated code to text then the virtual transcriptionist can automatically parse the code and automatically generate the report as described more fully herein. Because each transcriptionist may be able to hear the dictated codes, the specialist identifies the computer work area to which the code is associated. That allows the transcriptionists to filter out non-relevant communications across the shared audio communication path.

Still further, the transcriptionist station 118 provides a prepared report to the assigned computer work area 124 of the central reading station 122. The report is displayed within the assigned work area 124, optionally along with the medical image(s) and/or other relevant information from the medical case file. Each report, once approved by the specialist at the central reading station 122, is written to the database 114 and is delivered to the intended recipient (e.g., the medical facility server 108 of FIG. 1).

For instance, as illustrated, a transcriptionist station 118 operating a transcriptionist computer 126 (designated TRANS 1) is assigned to, and is thus uniquely associated with a first work area 124, (designated WORK AREA 1) of a central reading station 122. A transcriptionist station 118 operating a transcriptionist computer 126 (designated TRANS 2) is assigned to, and is thus uniquely associated with a second work area 124, (designated WORK AREA 2) of the central reading station 122. A transcriptionist station 118 operating a transcriptionist computer 126 (designated TRANS n−1) is assigned to, and is thus uniquely associated with a second work area 124, (designated WORK AREA n−1) of the central reading station 122. Analogously, a transcriptionist station 118 operating a transcriptionist computer 126 (designated TRANS n) is assigned to, and is thus uniquely associated with a second work area 124, (designated WORK AREA n) of the central reading station 122.

The team of transcriptionist stations 118 works together with a single specialist operating the central reading station 122 to evaluate medical images. Each transcriptionist computer 126 remotely accesses the assigned work area 124 of the central reading station 122 of the specialist. Each transcriptionist computer 126 can also optionally share control of an associated computer work area 124 (e.g., with specialist at the central reading station 122 or with another transcriptionist computer 126). However, when the transcriptionist computer 126 has control, the assigned transcriptionist has full remote access to the specialist's computer work area 124 and can open, close, use programs and type so that the type is displayed on the display screen allocated to the work area 124.

Because of the separate communication line of the shared audio communication channel 128 (e.g., a telephone line, VOIP connection, cellular connection, etc.), the central reading station/specialist can also audibly communicate with each transcriptionist station 118 independently of the network based computer connection that shares data between the various computer work areas 124 and the transcriptionist computers 126.

As such, when the specialist is viewing an image at a given work area 124, (e.g., WORK AREA 1), a first communication path for data is established between the computer work area 124 (WORK AREA 1) and the associated transcriptionist computer (TRANS 1). Likewise, a second communication path distinct from the first communication path is established between the specialist operating the central reading station 122 and the transcriptionist (or virtual transcriptionist) operating the first transcriptionist station 118 via the shared audio communication channel 128. As such, the specialist can speak/dictate directly with the corresponding transcriptionist station 118 (e.g., the transcriptionist or virtual transcriptionist operating transcriptionist computer 126). Likewise, the transcriptionist (or virtual transcriptionist) can communicate back to the specialist across the communication line of the shared audio communication channel 128 independently of communication across the remote computer connection between TRANS 1 and WORK AREA 1 (for example).

According to further aspects of the disclosure herein, in certain implementations, the shared audio communication channel 128 is an open and shared channel of communication, meaning that each communication is broadcast so that the specialist and each transcriptionist has access to all communications. Alternatively, communication can be selective (e.g., the specialist selects the transcriptionist to communicate with, the specialist selects combinations of transcriptionists to communicate with, the specialist and all transcriptionists are on an open communication, i.e., the shared audio communication channel 128 can be used for broadcast, one-to-one or one-to-many communications).

Each transcriptionist station 118 utilizes transcription codes 132 that represent the most common diagnoses associated with the types of images that the specialist reads. Thus, the specialist can look at an image within a computer work area 124 that is posted by the assigned transcriptionist. The specialist can then verbally communicate a transcription code over the shared audio communication channel 128 (e.g., the open telephone line, VOIP, cellular connection, etc.). The associated transcriptionist then enters the transcription code in to a computer program, and the computer program automatically pulls up a medical report corresponding to the transcription code entered by the transcriptionist.

Thus, when the specialist transitions from one computer work area 124 to the next, the assigned transcriptionist station 118 already has a case loaded onto the display screen of the associated work area 124. The specialist takes a moment to evaluate the medical case file. This may comprise, for instance, bringing up, zooming, processing or otherwise evaluating the image(s) associated with the medical case file, reading text, etc. Then, the specialist communicates the appropriate transcription code across the shared audio communication channel 128. The assigned transcriptionist at the associated transcriptionist station 118 causes a report to be automatically generated, and that automatically generated report appears on the display screen of the corresponding work area 124.

At this point, in some occasions, the specialist may make a minor change in the report, such as communicating the changes across the communication channel 128 to the assigned transcriptionist at the corresponding transcriptionist station 118. In this regard, the specialist views the report in the same computer work area 124 as the displayed medical record. As such, the specialist gives each medical file at least two looks: a first look for evaluation before the report is generated and a second look after the report is generated. This approach improves accuracy of evaluation because the report can be reviewed/audited by the specialist directly against the medical case file, including the medical image(s). Otherwise the report is done.

While the attention of the specialist is focused on a first one of the computer work areas 124, the remaining transcriptionists at the associated transcriptionist stations 118 are queuing new medical case files, preparing reports, sending reports, etc. As such, the specialist does not spend time on purely administrative tasks, and the specialist does not spend time loading, formatting, sending or otherwise processing reports and/or case information.

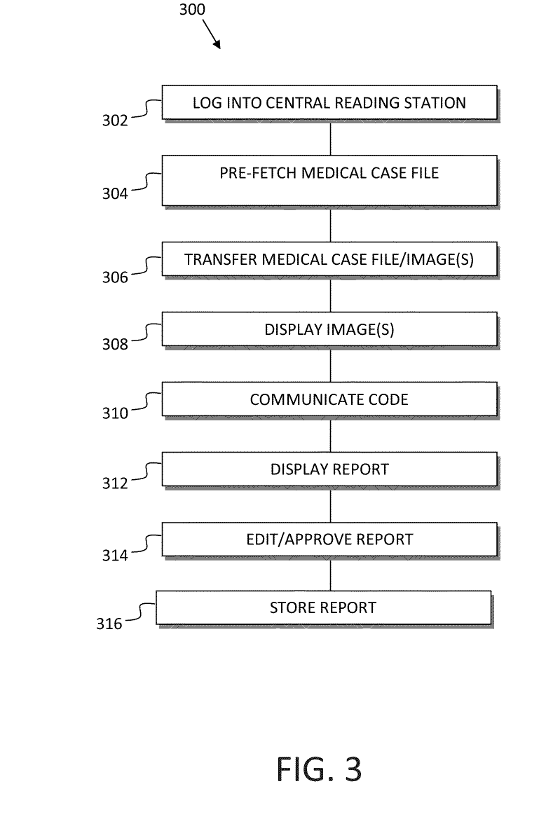

Referring to FIG. 3, a method 300 illustrates an exemplary approach for reading medical images using a teleradiology system, such as described above in reference to the FIG. 2. The method 300 may be implemented, for instance, as executable program code (e.g., stored on a computer-readable storage device) where the program instructs a processor to perform the method 300. The method may also be implemented by a computer system having a processor coupled to memory, where the memory has executable program code stored thereon, and the executable program code instructs the processor to perform the method 300.

A specialist logs into the central reading station at 302. A transcriptionist station (which does not need to be co-located with the specialist) is uniquely associated with each computer work area of the central reading station. As such, if the central reading station includes five work areas, there are five separate transcriptionist stations, one transcriptionist station uniquely associated with a corresponding computer work area.

A first software component allows each transcriptionist station to access and control the corresponding assigned computer work area of the central reading station. In an illustrative implementation, each transcriptionist station can gain control of only one computer work area (one-to-one relationship). However, this data communication is two-way so that at a given time, either the associated transcriptionist operating the transcriptionist station or the specialist operating the computer work area can control the corresponding computer work area. In alternative implementations, a transcriptionist station may be configured to process more than one computer work area, e.g., where a transcriptionist station includes two windows or separate transcription areas to keep the transcriptionist activities associated with each computer work area separate.

There is also a shared audio communication channel (e.g., common/shared voice communication line) connecting the specialist to all of the transcriptionists. As such, the specialist can speak/dictate to one or more transcriptionists of the transcriptionist team asynchronously. According to certain exemplary implementations, the shared audio communication channel is also a two-way communication channel in that the specialist and transcriptionists can each speak and hear communications across the shared audio communication channel. Moreover, the shared audio communication channel can be shared so that all transcriptionists of the transcription team can communicate, even amongst themselves, in an asynchronous manner (e.g., such as a telephone line that is open between the teleradiology location and each transcriptionist station simultaneously like a party line or conference call, or a voice over Internet protocol (VOIP) that is open between the teleradiology location and each transcriptionist station simultaneously). According to illustrative implementations, the shared audio communication channel is controlled at the teleradiology location to be selectively open between the teleradiology location and each transcriptionist station simultaneously.

Each transcriptionist has a series of transcription codes, where each code represents a diagnosis or other element to be included in a corresponding report. Codes are dictated by the specialist to each transcriptionist station, and the corresponding transcriptionist station uses the codes to generate a medical report. More particularly, according to aspects of the present disclosure, the specialist “batch processes” medical image interpretations in a two-step process. The first step is an evaluation process, and the second step is a verification process.

The evaluation process comprises pre-fetching medical case files at 304, transferring medical images to corresponding work areas at 306 and displaying the transferred medical images at 308. The specialist communicates a code corresponding to the medical case file being evaluated at 310 (e.g., across a shared audio communication channel to the assigned transcriptionist).

For instance, each transcriptionist station pre-fetches and loads a medical case file onto the corresponding computer work area of the central reading station by drawing a next case from a queue in the PACS server or other suitable database. By taking control of the assigned work area, each transcriptionist computer transfers/pre-loads at least one medical image of the pre-fetched medical case file to the assigned work area of the central reading station such that the medical case file information is displayed in an associated display area. The transcriptionist computer, through remote control, can also optionally load other suitable information into the associated work area. For instance, the transcriptionist computer can load information such as the medical history of the patient, the age of the patient, etc. The transcriptionist computer can also/alternatively provide comparison images, such as one or more baseline images, or the transcriptionist computer can remotely control and load other information into the computer work area of the associated central reading station that would assist the specialist in performing the diagnosis.

As such, the specialist has all of the information necessary to make a medical diagnosis available in a computer work area without the need to perform any administrative tasks to obtain the information directly. Moreover, the computer work area may provide necessary image processing tools for the specialist to interact with the information and medical image(s) to that the specialist can make an informed diagnosis. In an illustrative example, the work area comprises computer aided design (CAD) style software that manipulates the medical image(s) (e.g., to zoom, pan, suppress features, and perform other manipulations necessary to properly evaluate the medical case file).

The specialist can then step serially through the computer work areas. At each computer work area, the specialist manipulates the medical case file data that has been preloaded by the associated transcriptionist station.

The specialist then provides a code to the associated transcriptionist over the shared audio communication channel, where the code corresponds to the diagnosis. For instance, the specialist can dictate the code. The code can represent a diagnosis or other information to be entered into a report. As an alternative illustrative example, each code can define a type, style, format, etc. of the report. Still further, a plurality of pre-drafted reports can be provided. In this regard, the code indicates the report to be selected for the associated medical case file. In such a circumstance, the report can be further edited, customized, modified, etc.

The specialist then goes onto the next computer work area and interacts with the next transcriptionist station in an analogous manner. As the specialist is evaluating the next case, the transcriptionist associated with the previous evaluated case is preparing the report based upon the previously dictated code. The specialist does not need to go in any particular order within the group of computer work areas, so long as the medical case file is pre-loaded and is ready for evaluation by the time that the specialist gets to that computer work area. As such, the specialist can freely interact with the various computer work areas and dictate medical diagnosis via medical codes in an efficient manner. Moreover, the codes are transformed by the transcriptionist stations in-line so that the specialist does not waste time waiting for the codes to be transformed into reports.

In the verification process, each report prepared by a transcriptionist is displayed at the corresponding computer work area at 312. The specialist can review, optionally edit and approve the reports at 314. The approved reports are saved back out to the database (e.g., PACS) at 316.

Keeping with the above example, the specialist goes back through the computer work areas where a code has been dictated and reviews each report that has been generated by the associated transcriptionist based upon the received code. At this time, the specialist can request that the transcriptionist make changes (e.g., via the shared audio communication channel). The specialist may alternatively make changes directly to the report. Once approved, the specialist closes out the report. The associated transcriptionist sends the report out and draws the next case from the queue in the PACS server. When the specialist has signed off on each report, the next batch of cases is started and the above process repeats.

According to further aspects of the present disclosure, the report generator and correspondingly, the codes, are logically organized by body part/region. For instance, in an exemplary implementation, a plurality of different programs, modules, code sections, etc., are provided to specifically address the unique nature of the body part/region to be evaluated. By way of illustration, and not by way of limitation, a chest image can comprise a separate program, module, subroutine, etc. in a larger program that also accommodates different body parts. This allows the software to focus the report facilities on the key elements of the medical image. For instance, in a chest image, a specialist may be interested in inspecting features such as the heart, lungs, pulmonary vessels, costophrenic angles, etc. Each feature may have a different specification of classification (e.g., in terms of degree). As such, the report generator is “tuned” to uniquely address the issues of a chest image by understanding the features of the image, and the areas that the specialist is to inspect. In this regard, the report generating software is configured to comply with local, state, and federal standards and regulations (e.g., following the American College of Radiology (ACR) standards).

According to aspects of the present disclosure, the code that the specialist dictates over the shared audio communication channel is a concatenation of the entire diagnosis. As such, in certain cases, a single announced code consolidates the diagnosis for the entire associated report. The code is parsed by the transcriptionist to decipher the complete diagnosis.

In an illustrative example, each code is logically broken down into a three-part string that includes a concatenation of the body part/area, the diagnosis and the degree associated with the diagnosis, not necessarily in that order. Moreover, the codes may be based upon a categorization such as trauma, infection, neoplasm, vascular, idiopathic, other, etc.

By way of example, a specialist may evaluate a case and then dictate, over the common communication line, the code: 211RULC01. The corresponding transcriptionist that is uniquely associated with the corresponding transcriptionist computer parses this code into three fields, each field three characters long. For instance, 211=pneumonia; RUL=Right Upper Lobe; C=cardiomegaly, 01=no osteoporosis, mild osteoarthritis. Here, the third field is broken down into two sub-fields for purposes of illustration. The transcriptionist thus prepares a report diagnosing pneumonia in the right upper with cardiomegaly, showing no osteoporosis but mild osteoarthritis. In practice, any number of codes can be used. Moreover, the coding can take any number of formats. The system advantageously generates reports using consistent terminology. Moreover, the report generator translates the diagnosis into a format that flows, looks and reads like a report. This has an advantage of providing consistent and proper language despite using different transcriptionists in the report generating process.

According to further aspects of the present disclosure, the system further uses a random generator to replace at least one expression in the report with a differently worded but equivalent expression. For instance, the system uses an equivalency function to randomly replace certain key terms with synonyms/equivalents. Thus, if the specialist dictates the same code twice, it is possible that the literal verbiage of each report will be different, but the substance will be identical.

According to still further aspects of the present disclosure, the report generator provides the ability to save “instant clicks” to an “instant click menu” or other logical arrangement. This allows for words, phrases, sentences, one-liner additions, etc. that occasionally appear in reports to be quickly and easily pulled up and automatically inserted into the generated report. By way of example, a specialist evaluating X-rays (or transcriptionist assisting a specialist evaluating X-rays) may set an instant click for the one-liners “median sternotomy wires are noted, which appear intact,” and “right/left central venous catheter is present with tip located in the superior vena cava.” If an “instant click” is executed, the associated text appears in the report. Also, multiple additions can be added at one time. In certain illustrative implementations of the present disclosure, the report generator also includes the ability to add a “comparison date” if there is a prior exam. In this implementation, the system allows the ability to instant click on “improved,” “worsened,” “resolved,” “unchanged” with options of “mildly improved,” “mildly worsened,” “partial resolution,” “complete resolution,” etc. In practice, the text entered into the report can utilize the same verbiage as that associated with the meaning of the corresponding “instant click” button, or the text entered into the report can include more thorough verbiage reciting the meaning of the corresponding “instant click.”

Thus, each report can comprise a combination of template/automated content, transcriptionist entered content and optionally, specialist entered content. Moreover, regardless of the source of content, the report generator, according to certain aspects of the present disclosure, can dynamically randomize key words and phrases to use synonym/equivalent expressions. Still further, an overall report can consist of specialist transcribed edits, personalization, etc.

According to further aspects of the present disclosure, the specialist analyzes the medical image and is then almost immediately presented a report on the findings that states conclusions. As such, the specialist can approach a medical case file quickly and apply two different mindsets, first a mindset to analyze the medical image(s) and then a mindset to verify the accuracy of a report that sets forth the findings of the medical evaluation. Moreover, both evaluations can be carried out with the medical images in view for inspection, re-verification, a second look, etc.

In an exemplary implementation, a radiologist can increase the number of case files read per hour, and in some instances, may be able to significantly increase the number of cases read per hour compared to using conventional approaches. This increase in productivity can also create an increase in accuracy because the report is displayed back to the specialist quickly. Moreover, the specialist sees the report along with the medical image(s) and case file information, providing two or more fresh reads through the medical case file. As the report and case file are presented at the same time, there is an increase in accuracy because the verbiage of the report providing medical findings can be directly compared to the medical report and images.

As noted in greater detail above, various aspects of the present invention are applicable to medical images derived from a number of different modalities, e.g., MRI, CT, PET/CT, ultrasound, and plain film, etc. As such, each central reading station can be operated by a person having a sub-specialty in providing interpretations of medical images corresponding to a given modality, e.g., a sub-specialist at interpreting ultrasounds. However, depending upon the modality, the nature of the generated report will be different. Moreover, certain modalities require more complexities to the generated report compared to other modalities. For instance, a sub-specialist in interpreting ultrasound medical images may benefit from additional flexibility in automated report generation.

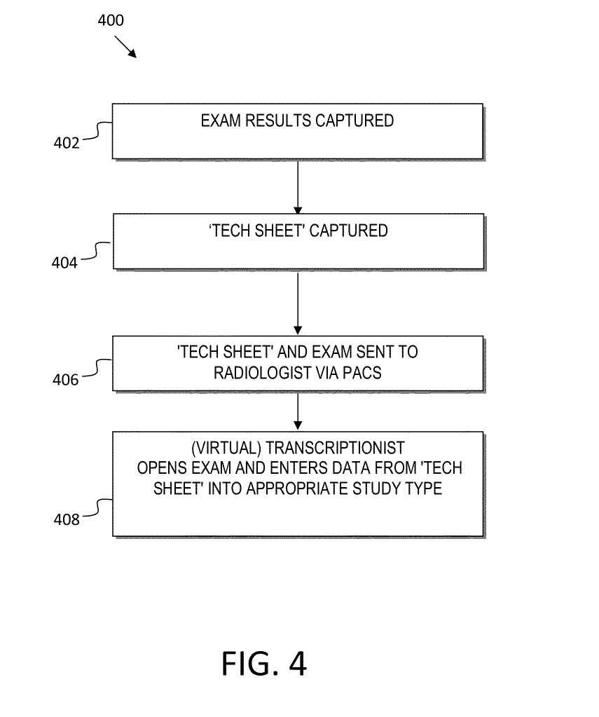

Referring to FIG. 4, a method 400 for generating a report is illustrated according to aspects of the present disclosure. The method 400 may be implemented, for instance, as executable program code, e.g., stored on a computer-readable storage device, where the program instructs a processor to perform the method 400. The method may also be implemented by a computer system having a processor coupled to memory, where the memory has executable program code stored thereon, and the executable program code instructs the processor to perform the method 400.

Test results are captured at 402. As an illustration, an ultrasound technologist, e.g., at a medical facility (see FIG. 1), performs an exam on a patient, and as a result of the examination, at least one ultrasound medical image is generated. A tech sheet is captured at 404 and is stored, for instance, on the server 108 (see FIG. 1). Moreover, the technologist utilizes a computer to determine and record organ measurements and optionally, other important findings. For instance, the tech sheet can capture computer-stored information such as “Gallstones, largest 1 centimeter (cm)”. As another example, a finding may digitally record in the tech-sheet, “No flow common femoral vein”.

At 406, the tech sheet and the medical case file, including one or more ultrasound medical images and other results of the examination are communicated from the server computer of the medical facility to a teleradiology center. For instance, the tech sheet and examination results can be communicated via PACS (e.g., server 108 to server 110, see FIG. 1). As yet another illustrative example, data is uploaded directly from an ultrasound machine to the PACS server 110 (FIG. 1) for processing. As yet another alternative implementation, data is uploaded from the ultrasound machine directly into the report generator software program described more fully herein. As such, the report generator generates a report instantly and automatically, often needing no changes at all, as will be described in greater detail herein. Alternatively, the transcriptionist at a corresponding transcriptionist station can manipulate the medical image(s) and generate, edit or otherwise manipulate a tech sheet, e.g., to capture measurements, enter or otherwise extract data, etc., that can be evaluated by the specialist.

The ultrasound image can be interpreted at the teleradiology center using approaches described more fully herein, e.g., the methods and systems of FIGS. 1-3. By way of illustration, a sub-specialist of ultrasounds operates a central reading station. A virtual transcriptionist in the team of virtual transcriptionists associated with the ultrasound specialist retrieves the tech sheet and corresponding medical image file. The transcriptionist then enters, copies, transfers or otherwise presents data from the tech sheet into an appropriate ultrasound study type, e.g., abdomen, lower extremity, venous, etc., of the report generating software and the study type is displayed in the corresponding computer work area of the central reading station.

The ultrasound specialist investigates the medical case file, including at least one ultrasound medical image and dictates the diagnosis to the assigned transcriptionist station, such as by dictating and encoded diagnosis over a shared audio communication channel as described more fully herein. The transcriptionist station generates a report of the medical findings for the specialist to review, and submits the report back to the computer work area, also as described more fully herein.

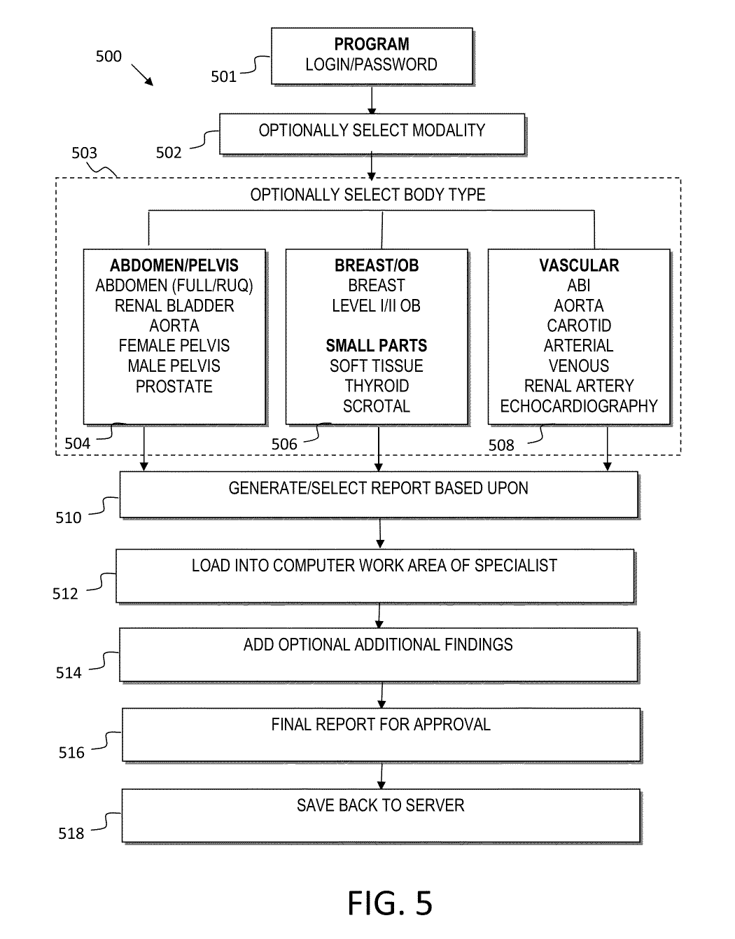

Referring to FIG. 5, a report generating program 500 (report generator) is illustrated in block diagram form according to aspects of the present disclosure. The report generating program may be implemented, for instance, as the “workflow manager” discussed above. In this manner, the report generator may be implemented as executable program code, e.g., stored on a computer-readable storage device, where the program instructs a processor to perform the program 500. The method may also be implemented by a computer system having a processor coupled to memory, where the memory has executable program code stored thereon, and the executable program code instructs the processor to perform the program 500.

The report generating program 500 is suitable with ultrasound and other modalities where teleradiological reports are required. An initial screen in a suitable interface allows a user to enter log-in credentials at 501, e.g., a user name and password. The user may be, for instance, one of the (virtual) transcriptionists assigned to work with an ultrasound specialist. The user can also comprise a specialist, e.g., a specialist working from the centralized reading station.

After successful login, a main screen allows the transcriptionist to select the appropriate modality, e.g., based upon the type of scan associated with a medical image in a retrieved medical case file, at 502. Optionally, the transcriptionist selects an appropriate body area (e.g., such as a body part) associated with the medical image at 503. For instance, in an illustrative implementation, the transcriptionist computer prepares a first medical case for evaluation by pre-fetching a first medical case file from a database. The medical case file has at least one medical image, and depending upon the type of file, may include a tech sheet that specifies at least one measurement of a feature in the corresponding medical image. The medical case file may also or alternatively include other information about the patient, about a past medical history, extenuating circumstances, etc.

The virtual transcriptionist can thus automatically select a report type and thus set up a preliminary draft of the medical report knowing the body area represented in the medical image, and knowing the modality (type of image), e.g., ultrasound, CT, MRI, etc. Knowing the type of scan of the medical image, and knowing the body part allows the report generator to automatically select or otherwise reduce the available options for diagnosis, making the report generation, editing and auditing more efficient, as will be described in greater detail herein.

As an illustrative example, after a transcriptionist logs into the report generator, assume that a transcriptionist selects “Ultrasound” as the appropriate modality at 502. The transcriptionist next enters a selection that limits the Ultrasound to an appropriate study type 504, 506, 508. In this manner, the study type classifies the particular medical image to a body area.

By way of illustration, and not by way of limitation, the ultrasound study type at 504 comprises an abdomen/pelvis study type and can include fields for information pertaining to the patient's abdomen (full/RUQ), renal bladder, aorta, female pelvis, male pelvis, prostate, etc. Another exemplary ultrasound study type at 506 comprises breast/OB, including breast level I/II OB, small parts such as soft tissue, thyroid, scrotal, etc. As yet another illustrative example an ultrasound study type at 508 can track information such as vascular, ABI, aorta, carotid, arterial, venous, renal artery, echochardiography, etc.

Of course, if the transcriptionist selected another type, e.g., a Computed Tomography (CT), Magnetic Resonance Imaging (MRI), etc., it is possible that different body areas would be presented as options. For instance, a CT or MRI may present body areas such as the brain, neck, chest, abdomen, pelvis, cervical thoracic or lumbar spine or shoulder. It also possible to use additional selections, e.g., via menus or sub-menus, categories or sub-categories, drive down options, etc., to further limit the scope of the analysis, e.g., to a general extremity, elbow, wrist, hand, finger, hip, pelvis, knee, tibia fibula, ankle, foot, toe, etc. The above is extensible to other specialties and sub-specialties. As such, the above is not intended to be limiting, but rather, is intended to be illustrative of different ways to structure the input selection.

At 510, a report is automatically generated by the report generator, e.g., as directed by the workflow manager software. As an illustrative example, the report generator applies at least one rule to determine whether an aspect of a medical image is normal or abnormal. Utilizing information from the result of applying the rule and the selected report type, the report generator automatically generates a preliminary report, which can include a preliminary finding, depending upon the applied rule(s).

By way of illustration, keeping with the example of an ultrasound, the pre-fetched information can include a tech sheet that stores at least one measurement of a feature in the corresponding medical image of the medical case file. Here, the report generator parses the tech sheet associated with the pre-fetched medical case file to identify at least one measurement in the tech sheet. In this example, a rule may be applied to determine whether the extracted measurement is normal, abnormal, out of tolerance, etc. This information may be used to derive a preliminary finding. The virtual transcriptionist may also and/or alternatively manually or automatically (via the report generator) enter additional information from the tech sheet or other information in the medical case file into the preliminary report, e.g., based upon the study type that was previously selected.

As an additional example, the report generation program 500 accesses a database to decide if values that are provided as measurements from the tech sheet (where provided) are normal, abnormal, etc. In illustrative implementations, the report generator automatically adds a first statement to the report if the applied rule determines that at least one measurement is normal, and a second statement to the report if the applied rule determines that the at least one measurement is abnormal. For instance, if the software report generator determines that a measurement is normal, e.g., based upon rules, a table lookup operation, etc., the report generator automatically provides a statement in the report that is indicative of the normal condition. For instance, a report entry may include a statement that “the liver is of normal size”. If the software report generator determines that a measurement is abnormal, a statement may be added that the “liver is abnormal in size”.

If the software report generator determines that a measurement is abnormal, e.g., based upon rules, a table look-up operation, etc., the report generator automatically provides a statement in the report indicative of the abnormal finding and conclusion. For instance, if a transcriptionist enters a spleen size of 16 cm, the report generator program will generate a report entry, such as in a findings section of the generated report that states by way of example, “the spleen is enlarged measuring 16 cm.”

Still further, according to illustrative implementations, the report generator provides alerts if input values are out of range. For instance, if a virtual transcriptionist enters a bile duct size of 15 cm instead of 15 mm, which is off by a magnitude due to wrong units, the report generator flags the error. The report generator can alert the transcriptionist that the entered or otherwise read input value is suspected of being out of range.

In this regard, according to certain illustrative implementations of the present disclosure, the report generator can distinguish a given input between at least three different conditions. That is, the input can be normal (or within normal limits), the input can be abnormal (within abnormal limits from a medical diagnosis perspective) or the input can be out of range, e.g., a measurement or other input value that is unreasonable from a medical diagnosis perspective.

Moreover, the report generator will automatically generate a conclusion. Keeping with the above example, the report generator can automatically generate a conclusion such as: “1. Splenomegaly”.

Accordingly, the report generator can audit inputs provided in a medical report, such as a measurement of a feature in a medical image from an ultrasound. Accordingly, various aspects of the present disclosure provide a way to audit an interpretation by the specialist, the (virtual) transcriptionist, the medical technician that made the measurement, the medical test equipment itself, e.g., the ultrasound machine, or combinations thereof. Moreover, by providing the automatically generated finding to the specialist while the medical image is also being displayed, the specialist can audit the capability of the report generator, and more easily detect errors, e.g., errors as a result of data entered by the technician that made the measurement, the transcriptionist that entered the information into the report, etc.

The ability of the report generator to intelligently evaluate conditions is not limited to measurements. To the contrary, any feature that can be graded, scaled, categorized, differentiated or otherwise diagnosed can be included in the set of rules processed by the report generator. Moreover, the rules automatically implemented by the report generator, which are created to characterize detected condition(s) can include multiple predicates, nested and/or complex predicates, conditions, preconditions, etc., take into account comparisons across multiple medical images (e.g., by comparing a baseline image to a current image) or take advantage of other manipulations to derive intelligent checks on the overall diagnosis, on conditions and data used to establish a diagnosis, or combinations thereof.

According to still further aspects of the present disclosure, the rules implemented by the report generator can be customized by the specialist. As such, a specialist can create, edit and delete rules, conditions, requirements, etc., to carry out the necessary automated processing implement the desired medical verification. As such, a specialist may define the ranges that determine conditions, such as normal, abnormal, out of range, etc. Alternatively, the specialist may be able to create completely new rules. By way of illustration and not by way of limitation, the report generator program can be programmed to treat a spleen measurement in excess of a predetermine size, e.g., 14 cm, as being enlarged. However, the programmable nature allows rules, settings, preferences and/or other parameters to establish the particular outcomes for corresponding events/measurements. If a range is out of value, e.g., 14 m or 1.4 mm (clearly erroneous values), the report generator program can ask a user to enter a new value. Otherwise, the report generation process can be carried out as described more fully herein.

At 512, the transcriptionist computer transfers the medical image of the medical case file and the preliminary report to a computer work area of a central reading station. For instance, as described more fully herein, in an illustrative implementation, the transcriptionist computer takes control of the appropriate computer work area of the specialist operating a central reading station as described more fully herein. The transcriptionist computer loads the image, the report and any additional information. After the specialist reviews the medical image and preliminary report (where provided) within the computer work area, the transcriptionist station receives a response from the central reading station. The transcriptionist computer then sends a final version of the report associated with the medical case file to the database for storage after receiving approval from the specialist operating the central reading station.

A response from the central reading station may comprise approval of the preliminary report. Alternatively, a response from the central reading station may comprise a communication of a code corresponding to an analysis of the medical case file across a shared audio communication channel from the central reading station to the transcriptionist station. In this scenario, the transcriptionist computer modifies the preliminary report to derive the final report based upon the code by parsing the received code into a plurality of fields, each field corresponding to a component of a diagnosis of a specialist at the central reading station and modifying the report by generating text for the report that is selected based upon the code value of each parsed field, as described in greater detail herein.

For instance, at 514, the specialist optionally dictates further findings to add to the report or the specialist may dictate codes that more accurately define the medical diagnosis. At 516, the transcriptionist presents the final report to the specialist. At 518, copies of the automatically generated report are saved back out to the PACS. For instance, the virtual transcriptionist can save copies of the final report into PACS and bring up images, the tech sheet and final report for review by the specialist. According to certain aspects of the present disclosure, a significant percentage of reports are likely not to need changes if done by a trained virtual transcriptionist.

According to further aspects of the present disclosure, during report generation, the selection of a study type, e.g., selecting between the types 504, 506, 508, e.g., using a suitable graphical user interface (GUI) can be expanded to include any number of types, including CT, MRI, etc. Moreover, each selected study type can launch a specialized report generator specifically tailored to the specific category of the study type, or a generalized program can use the selection of the study type as a filter to customize the data generated for the report. Moreover, not all study types will include a tech sheet. Here, the process is the same as that outlined above, except that a measurement is not automatically extracted.

The specialist reviews the images and other information in the associated computer work area and communicates the medical findings (e.g., any detected abnormalities) directly with a transcriptionist station (e.g., virtual transcriptionist or person functioning in the role of transcriptionist). The transcriptionist enters the findings into the report generator via the code as described more fully herein. A full report is generated containing any detected abnormalities plus normal statements for the other aspects of the evaluation, e.g., a CT or MRI for the appropriate body part represented in the medical image.

Furthermore the CT and MRI report generator programs are intelligent much like that set out above in the example of the ultrasound report generator. For example, if on an MRI of the brain, a mass is chosen within a certain location with certain imaging characteristics as entered in the program, the automatically generated report will instantly include the appropriate differential diagnoses from a reference table as would be included by a subspecialist in that particular field of imaging (e.g., Neuroradiology, musculoskeletal). As another example, given a CT generator, if for example, there is a liver mass, the program will automatically put the correct differential diagnoses in the report as well.

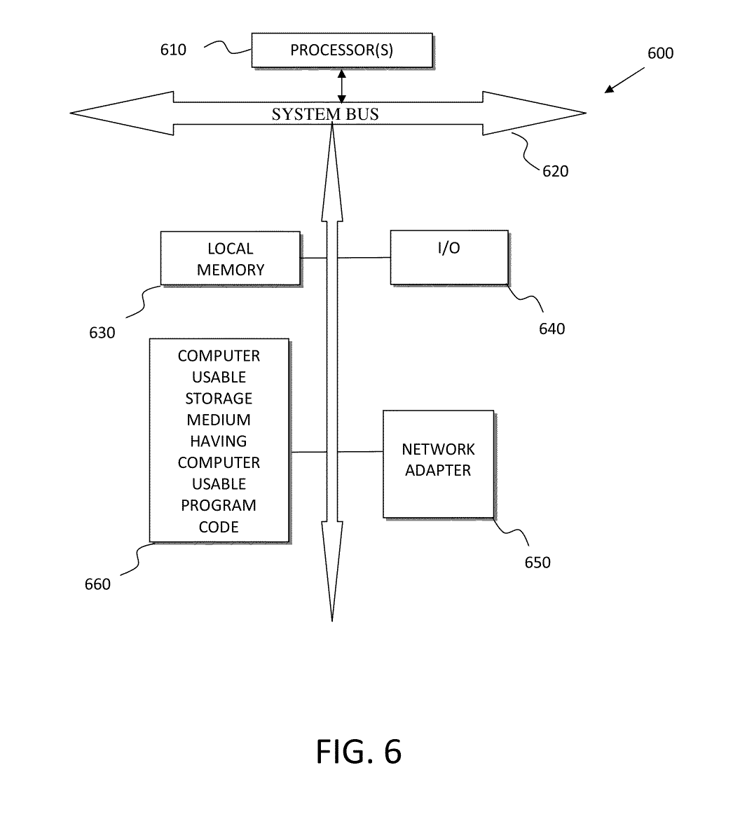

Referring to FIG. 6, a block diagram of a system of a data processing device 102, 108, 110, 122, 126 (e.g., as described in FIGS. 1 and/or 2), is depicted in accordance with the present disclosure. Data processing system 600 may comprise one or more processors 610 connected to system bus 620. Also connected to system bus 620 is memory controller/cache that provides an interface to local memory 630. An I/O bus bridge provides an interface to an I/O bus that supports one or more buses and corresponding devices such as input output devices (I/O devices) 640. A network adapter 650 enables the data processing system to communicate with other devices through intervening private or public networks.

Also connected to bus is storage 660, which includes a computer usable storage medium having computer usable program code embodied thereon. The computer usable program code is executed to implement any aspect of the present disclosure, for example, to implement any aspect of any of the methods and/or system components illustrated in FIGS. 1-5. Moreover, the computer usable program code may be utilized to implement any other processes that are associated with teleradiology, or other aspects as set out further herein.

As will be appreciated by one skilled in the art, aspects of the present disclosure may be embodied as a system, method or computer program product. Accordingly, aspects of the present disclosure may take the form of an entirely hardware embodiment, an entirely software embodiment or an embodiment combining software and hardware aspects. Furthermore, aspects of the present disclosure may take the form of a computer program product embodied in one or more computer readable storage medium(s) having computer readable program code embodied thereon.

Any combination of one or more computer readable medium(s) may be utilized. A computer readable storage medium may be, for example, but not limited to, a portable computer diskette, a hard disk, a random access memory (RAM), a read-only memory (ROM), an erasable programmable read-only memory (EPROM or Flash memory) or any suitable combination of the foregoing. In the context of this disclosure, a computer readable storage medium may be any tangible medium that can contain or store a program for use by or in connection with an instruction execution system, apparatus, or device.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks and/or provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A method of preparing and processing medical reports comprising:
preparing a first medical case for evaluation by a first transcriptionist computer, the preparation including:
pre-fetching a first medical case file from a database, the medical case file having at least one medical image;
selecting a modality of the at least one medical image;
selecting a body area associated with the selected modality;
automatically selecting a report type based upon the selected modality and selected body area;
applying at least one rule to determine whether at least one aspect of at least one medical image is normal or abnormal; and
utilizing information from the results of at least one applied rule and the selected report type to automatically generate a preliminary report having a preliminary finding;
transferring the least one medical image of the first medical case file and the preliminary report to a first computer work area of a central reading station, the first computer work area remote from the first transcriptionist computer;
receiving a response from the central reading station; and
sending a final version of the report associated with the first medical case file to the database for storage after receiving approval from the first computer work area.

2. The method of claim 1 further comprising:
pre-fetching a tech sheet that stores at least one measurement of a feature in the corresponding medical image of the first medical case file;
parsing the tech sheet associated with the pre-fetched medical case file;
identifying at least one measurement in the tech sheet; and
entering information from the tech sheet into the preliminary report;
wherein:
applying at least one automated rule comprises applying a rule to determine whether the at least one measurement is normal.

3. The method of claim 1, wherein:
receiving a response from the central reading station comprises:
receiving a communication of a first code corresponding to an analysis of the first medical case file across a shared audio communication channel from the central reading station to the first transcriptionist station; and
modifying the preliminary report to derive the final report based upon the first code received by the first transcriptionist station by:
parsing the received code into a plurality of fields, each field corresponding to a component of a diagnosis of a specialist at the central reading station; and
modifying the report by generating text for the report that is selected based upon the code value of each parsed field.

4. The method of claim 3 further comprising:
replacing text selected for the report based upon a parsed field with an equivalent expression.

5. The method of claim 1, wherein applying at least one rule further comprises determining the at least one measurement is normal, abnormal or out of range.

6. The method of claim 1 further comprising extracting examination results from at least one of a tech sheet and medical image file.

7. The method of claim 1, wherein automatically selecting a report type based upon the selected modality and selected body area comprises selecting a report type for an ultrasound image from at least one body area comprising: abdomen, lower extremity and venous.

8. The method of claim 1, wherein automatically generating an preliminary report by the first transcriptionist computer further comprises automatically adding a first statement to the report if the applied rule determines that the at least one measurement is normal, and a second statement to the report if the applied rule determines that the at least one measurement is abnormal.

9. The method according to claim 1, wherein applying at least one rule comprises using a table look up to look up a result based upon a predicate associated with the medical image.

10. The method of claim 1, wherein automatically generating a preliminary report further comprises automatically adding a statement to the report based upon detecting an operation of an instant click button.

11. The method of claim 1 further comprising providing an interface to add rules to a rules engine, and to modify parameters associated with the rules such that each specialist has a customized set of rules.

12. A method of preparing and processing medical reports comprising:
connecting to a database that stores a plurality of medical case files, where the database is accessible by a transcriptionist station having a transcriptionist computer;
providing information from a medical case file to a central reading station, the medical case file having at least one medical image for analysis and a tech sheet storing at least one measurement of a feature in the corresponding medical image by:
obtaining the medical case file from the database;
parsing the tech sheet associated with the obtained medical case file;
identifying at least one measurement in the tech sheet;
applying at least one rule to determine whether the at least one measurement is normal or abnormal;
automatically generating a report by the transcriptionist computer; and
providing information from the obtained medical case file, including at least one medical image and the report, to the central reading station; and
storing the report in the database once approved by the specialist at the centralized reading station.

13. The method according to claim 12, further comprising:
communicating a code across a shared audio communication channel that facilitates audio communication between a specialist at the central reading station and the transcriptionist station; and
modifying the report based upon the code received by the transcriptionist station.

14. The method according to claim 13, further comprising:
receiving at the central reading station, a report prepared by the transcriptionist computer, where the report is based at least in part, upon the received code transmitted to the transcriptionist station over the shared audio communication channel such that the received report is presented with the medical image at the same time.

15. The method according to claim 13, further comprising:
replacing text selected for the report with an equivalent expression based upon a parsed field within the communicated code.

16. The method of claim 12, wherein applying at least one rule further comprises determining the at least one measurement is normal, abnormal or out of range.

17. The method of claim 12, further comprising extracting examination results from at least one of the tech sheet and medical image file.

18. The method of claim 12, wherein automatically generating a report further comprises automatically adding a first statement to the report if the applied rule determines that the at least one measurement is normal, and a second statement to the report if the applied rule determines that the at least one measurement is abnormal.

19. The method of claim 12, wherein automatically generating a report further comprises automatically adding a statement to the report based upon detecting an operation of an instant click button.

20. The method of claim 12, further comprising providing an interface to add rules to the rules engine and to modify parameters associated with the rules such that each specialist has a customized set of rules.
